(19) United States
(12) Patent Application Publication
(10) Pub. No.: US 2018/0086983 A1
(43) Pub. Date: Mar. 29, 2018

(54) PROCESS FOR PREPARING PRODUCT OIL FROM PEAT, COIR OR PEAT-LIKE SUBSTANCES

(71) Applicant: STUDIENGESELLSCHAFT KOHLE MBH, Mülheim an der Ruhr (DE)

(72) Inventors: Roberto RINALDI, Mülheim an der Ruhr (DE); Marco KENNEMA, Mülheim an der Ruhr (DE)

(73) Assignee: STUDIENGESELLSCHAFT KOHLE MBH, Mülheim an der Ruhr (DE)

(21) Appl. No.: 15/560,595

(22) PCT Filed: Mar. 22, 2016
(86) PCT No.: PCT/EP2016/056265

§ 371 Date: Sep. 22, 2017

(30) Foreign Application Priority Data
Mar. 24, 2015 (DE) 10 2015 205 360.1

(51) Int. Cl. C10G 1/08; C09K 17/14

(52) U.S. Cl. CPC C10G 1/086; C10G 2300/44; C09K 17/14; C10G 1/083

(57) ABSTRACT

The present invention refers to a process for catalytic fractionation of peat, coir, peat-like materials or mosses into a non-pyrolytic bio-oil and a sterile solid fraction with similar volume and structural function to the starting material. The inventive process is useful for a variety of interesting applications, starting from raw peat with a water content of up to 80% resulting in a an oil, rich in polyols and aliphatic molecules.

The present invention refers to a process for the treatment of peat, coir, peat-like substances or mosses, rendering a product oil and a sterile solid fraction with preserved structural function of peat as a soil additive. The invention uses transition metal or transition metal oxide catalysts, either directly, or base co-catalyzed, using either strong or weak bases as the co-catalysts. The innovative process yields a high weight percentage fraction of product oil at temperatures much less severe than pyrolysis to achieve the same yield. The process can start from peat with water content of 0.1%-80% and still achieve a high yield of product oil. The process retains approximately the original volume of the starting material from which a number of applications may be realized including but not limited to: a soil additive, enzymatic hydrolysis, and heating fuel. In addition the process results in a sterile solid fraction with low water content when compared to conventional peats.

Innovative processes are required for the future production of low cost hydrocarbon feedstocks from natural sources. In order to realize these objectives a combination of new processes and improving existing processes is required. Renewable sources of hydrocarbons are a challenge for economic production of fuels due to their complex nature, variability in the feedstock, and typically seasonal dependence on agricultural availability. To add to this, for the current state of the art processes (fast pyrolysis) the material must be dried to 5-15% (M. I. Jahirul, M. G. Rasul, A. A. Chowdhury, N. Ashwath, Energies 2012, 5, 4952-5001). Most of the research relating to the conversion of peat into hydrocarbon feeds is centered around pyrolysis, focusing on fast and flash pyrolysis techniques. These processes involve high temperatures (greater than 350° C.) to deconstruct the complex polymeric organic material. The products of the process are a liquid (pyrolysis oil/bio-crude), gas (typically a mix of H₂O, CO, CO₂ and CH₄) and a solid (bio-char). Although these processes can produce pyrolysis oil at high yields (fast pyrolysis: ˜50%, flash pyrolysis: 75-80% yield) (M. I. Jahirul, M. G. Rasul, A. A. Chowdhury, N. Ashwath, Energies 2012, 5, 4952-5001.), the process must start from a dried material (water content: 10-15%), which is a challenge when working with peat which is typically harvested at 50-70% H₂O depending on the level of humification. Furthermore, the complexity of the process engineering in dealing with a solid, liquid and gas product, as well as major heat and mass transport losses, has limited the peat pyrolysis to research applications at this point.

The conversion of biomass into hydrocarbon products is part of the global direction to improve bio-fuels for combustion engines. In the fast pyrolysis of biomass to bio-oil, an increase in energy density by a factor of 7 to 8 is achieved (P. M. Mortensen, J. D. Grunwaldt, P. A. Jensen, K. G. Knudsen and A. D. Jensen, Appl. Catal. A-Gen., 2011, 407, 1-19). In spite of this, with an oxygen-content as high as 63 wt %, bio-oil still has an energy density of about 50% of diesel. To add to these challenges, pyrolysis oil production must be conducted at temperatures above 350° C. in order to achieve an appreciable yield of oil. Reactor designs currently struggle to maintain heat transport from the reactor to the heat transfer medium and from the heat transport medium to the biomass. This is also due to the heating rate required for pyrolysis, 10-200° C./s for fast pyrolysis or >1000° C./s for flash pyrolysis.

Typically, the chemical functionalities of molecules present in pyrolysis oil are considerably reactive and cannot be separated economically to realize their potential as bulk or fine chemicals. To circumvent these problems, the bio-oil must be upgraded to decrease its oxygen-content and reactivity. There are two standard routes for upgrading pyrolysis oil as discussed in great detail in (P. M. Mortensen, J. D. Grunwaldt, P. A. Jensen, K. G. Knudsen and A. D. Jensen, Appl. Catal. A-Gen., 2011, 407, 1-19), namely hydrodeoxygenation (HDO) and “zeolite cracking”. These routes are outlined as the most promising avenues to convert pyrolysis oil into engine fuels. In HDO processes, pyrolysis oil is subjected to high pressures of H₂ (80-300 bar) and to high temperatures (300-400° C.) for reaction times up to 4 h. In the best cases, these processes lead to an 84% yield of oil. The HDO processes are performed with sulfide-based catalysts or noble metal supported catalysts. In the cracking of bio-oil using zeolites, the upgrade is conducted under lower pressures for less than 1 h, but temperatures up to 500° C. are necessary for obtaining yields of oil as high as 24%. In both processes, the severity of the process conditions poses a major problem for the energy-efficient upgrading of bio-oil and the thermal stability of pyrolytic bio-oil. A controlled deconstruction of peat could result in products that maintain their functionality while still retaining the ability to be separated via distillation. This feature results in a higher value product, improving the economic aspect of production of oil from peat.

Pyrolysis is a process through which the whole peat is deconstructed without retaining the original function of the starting material. The conversion of the whole plant biomass during pyrolysis leads to pyrolytic bio-oil, gaseous products, and biochar. As matter of fact, pyrolysis of peat results in a considerable lost of renewable carbon owing to undesirable formation of gaseous products and biochar. Moreover, significant challenges still exist in the stability and acidity of pyrolysis oil. The reactive oxygen functionalities lead to polymerization reactions which result in an increase in molecular weight, increase in viscosity and in some cases separation into two phases a thick high molecular weight hydrocarbon fraction and a low molecular weight fraction containing a number of functional groups and high concentrations of H₂O, decreasing the combustion properties of both fractions (M. I. Jahirul, M. G. Rasul, A. A. Chowdhury, N. Ashwath, Energies 2012, 5, 4952-5001).

Some of the major challenges facing the use of biomass as a source of fuel production is the variability of the feedstock, typical seasonal dependence of the feedstock, and transportation of the biomass to a central upgrading facility. The cost of collection, transportation and storage of plant biomass could represent 35-45% of the final cost of the pyrolysis oil produced. In contrast, the initial cost of the plant only represents 10-15% (M. I. Jahirul, M. G. Rasul, A. A. Chowdhury, N. Ashwath, Energies 2012, 5, 4952-5001). The costs associated with plant biomass processing through pyrolysis do not exist for pyrolysis oil from peat, as the material is already harvested and transported to a central upgrading facility for processing.

The inventors recognize that some of the main challenges with biomass conversion are harvesting, transportation, storage of the biomass, the variability in the chemical complexity and composition of the feedstock, as well as the initial water content in the biomass. The process for the catalytic treatment of peat, coir, peat-like substances, or mosses is a process option to address these problems, while producing a high quality product oil and a sterile soil additive with similar properties to the starting material.

In the inventive process, peat is treated with an organic solvent and H-donor (e.g. secondary alcohols, preferably 2-propanol and 2-butanol), mixtures of different organic solvents (e.g., primary and secondary alcohols) including a mixture thereof with water in the presence of metal catalyst. The process is performed in absence of hydrogen , in particular in the absence of externally supplied pressure of hydrogen. The reaction mixture can be separated into two fractions, the first one being product oil and the second one a solid fraction.

The H-donor is generally selected from primary and secondary alcohols having 3 to 8 carbon atoms, preferably ethanol, 2-propanol, 2-butanol, cyclohexanol or mixtures thereof. Cyclic alkenes, comprising 6 to 10 carbon atoms, preferably cyclohexene, tetraline or mixtures thereof can be used as H-donor. In addition, formic acid can be also used as an H-donor. Furthermore, polyols comprising 2 to 9 carbon atoms can be used as an H-donor, preferably ethylene glycol, propylene glycols, erythritol, xylitol, sorbitol, mannitol and cyclohexanediols or mixtures thereof. Saccharides selected from glucose, fructose, mannose, xylose, cellobiose and sucrose can be also used as H-donor.

As a catalyst, any transition metal or transition metal oxide can be used as much as it is suitable for building up a skeleton catalyst. The metal catalyst can be suitably a skeletal transition metal catalyst or supported transition metal catalyst or skeletal transition metal oxide or supported transition metal oxide or a mixture of the aforementioned catalysts, preferably skeletal nickel, iron, cobalt or copper catalysts or a mixture thereof. Generally, the metal can be selected from nickel, iron, cobalt, copper, ruthenium, palladium, rhodium, osmium iridium, rhenium or their corresponding oxides or mixtures thereof, preferably nickel, iron, cobalt, ruthenium, copper or any mixture thereof. Metal catalysts prepared by the reduction of mixed oxides of the above mentioned elements in combination with aluminum, silica and metals from the Group I and II can also be used in the process.

In addition to the aforementioned transition metal and transition metal oxides, a base can be used as a co-catalyst for the process. The base can be strong consisting of the alkali or earth alkali metals or it could be weak as in the case of any organic amine.

As an option, the catalyst can be a bifunctional solid comprising metal functionality and acid sites wherein said acid sites being preferably functional sites having acidic Brønsted or Lewis functionality or both.

In an example, the combined process consists of a batch reaction in which raw peat or dried peat is treated with organic solvents (alcohol-water mixtures) with the addition of skeletal Ni catalyst as a catalyst for hydrogen-transfer reactions. No gaseous hydrogen is added. The process is performed under autogeneous pressure only. After the process completion, skeletal Ni catalyst is easily separated from the product mixture by means of a magnet, since skeletal Ni catalyst and Ni catalysts show magnetic properties. The catalyst-free mixture is then filtered in order to separate the solution comprising product oil and solid fraction. After distillation of the solvent mixture, the product oil is isolated.

Outlined are the advantages of this process over the current state-of-art:
The process can start from crude peat with high H₂O contents (0.1-80%);
The production of a bio-oil does not involve the pyrolysis of the substrate.

Accordingly, structural volume provided by the peat is unaltered or slightly reduced, even considering a significant decrease in weight, and this material can be utilized in the same function as the starting material, as a structural additive to soil, providing high water/nutrient retention and porosity;
The solid fraction produced is a sterile medium containing a very low content of the original microorganisms in the starting material;
A yield of up to 48% of oil was achieved at a process temperature of 200° C. far below of the temperatures required for attaining the same yield of oil using pyrolysis (400-1000° C.)
A solid fraction and an oil are produced without the production of a high volume of gas
A high content of furan and polyalcohol derivatives are isolated from the catalytic fractionation of peat.
The process is performed in absence of externally supplied molecular hydrogen. In effect, the costs associated with the reactors resistant to so molecular hydrogen are fully avoided.
The process is catalytic. In contrast, the state-of-art processes are stoichiometric. The metal catalyst is recyclable for many times that mitigates the waste generation.
The quality and properties of the process can be tuned by adjusting the catalyst or the solvent mixture used.
The process is applicable to all peats, coir and peat-like material regardless of the level of humification, or water content.

In more detail, the present invention refers to a process for production of product oil rich in polyols, long chain aliphatics in addition to a sterile solid component with similar properties to the starting material, by H-transfer reactions performed on peats, coir, peat-like substrates and mosses in the presence of skeletal Ni or NiOₓOₓ catalyst or other metal catalyst in addition to an H-donor (an alcohol) comprising the steps of:
a) subjecting peat material to a treatment at a temperature range from 130° C. to 300° C., preferably 160° C. to 260° C., most preferably 170° C. to 240° C., in a solvent system comprising an organic solvent or mixture of solvents, preferably alcohols and water in the presence of a catalyst, preferably skeletal Ni catalyst, in absence of externally supplied molecular hydrogen, under autogeneous pressure in a reaction vessel for a reaction time of 1 to 8 hours,
b) removing the catalyst from the reaction mixture, preferably by means of magnetic forces,
c) filtering the reaction mixture to separate the raw product oil from the solid fraction, and optionally,
d) removing the solvent system from the filtrate to concentrate the product oil.

In the inventive process the peat material or humic material is preferably a particulate material in the form of peat, preferably Spagnum, Carex, coir, a mixture, or any other peat-like material or moss.

The process can be performed as a one-pot process, that is, substrate and catalyst are suspended in a solvent mixture and cooked at the temperature ranges aforementioned. Alternatively, the process can be carried out as a multi-stage process in which the liquor obtained from the reaction where the substrate is cooked is continuously transferred into another reactor comprising the catalyst, and the processed liquor returned to the main reactor where the substrate is cooked.

The inventive process is applicable to any type of peat or coir or peat-like material or moss.

As mentioned above, the solvent system comprises an organic solvent or mixtures thereof which are miscible with water and is preferably selected from lower aliphatic alcohols having 1 to 6 carbon atoms and one to three hydroxy groups, preferably methanol, ethanol, propanol, 2-propanol and 2-butanol or mixtures thereof. Thus, the solvent system can be a solvent mixture of a lower aliphatic alcohol having 1 to 6 carbon atoms and water, preferably in a v/v-ratio of 99.9/0.1 to 0.1/99.9, preferably 10/90 to 90/10, most preferably 20/80 to 80/20, alcohol/water solutions.

In particular, the solvent system is a solvent mixture of secondary alcohols (e.g. 2-PrOH, 2-butanol, cyclohexanol) and water in a v/v-ratio of 80/20 to 20/80, alcohol/water solutions.

Other solvents, such as aliphatic or aromatic ketones having 1 to 10 carbon atoms, ethers having 2 to 10 carbon atoms, cyclohexanols, cyclic ethers (preferably, tetrahydrofuran, methyltetrahydrofurans or dioxanes) and esters (preferably, ethyl acetate and methyl acetate) can be added into the solvent fraction as modifiers. The volume fraction of the modifier in the solvent mixture, also containing secondary alcohol or mixture thereof and eventually water, ranges from 0.1 to 99.9%, preferably 1 to 95%, most preferably 5 to 70%.

The process operates at weight ratio of catalyst-to-substrate from 0.001 to 10, preferably 0.01 to 5, most preferably 0.05 to 2.

The inventive process can yield a sterile solid fraction 50 to 80-wt %, which maintains the same porosity and water retention.

Thus, the present inventors have demonstrated a new and inventive catalytic process for the production of a product oil from peat substrates in the presence of skeletal Ni catalyst and under low-severity conditions. A solvent mixture of 2-PrOH and water 70:30 (v/v) at temperatures above 180° C. result in the highest yield of oil. In the product oil, vinyl and carbonylic groups, such as carboxylic acids, ketones, aldehydes, quinones are reduced, while most polyol and aliphatic structures are largely preserved.

### RESULTS

TABLE 1
Weight yields of product oil and solid fraction (given as dry values)

| | | Humification | Product | |
|---|---|---|---|---|
| Entry | T (° C.) | level | oil (wt %) | Solid fraction (wt %) |
| 1 | 180^{a} | H3-H4 | 40 | 54 |
| 2 | 180^{a} | H5-H6 | 29 | 61 |
| 3 | 180^{a} | H6-H7 | 34 | 58 |
| 4 | 180 | H6-H7 | 29 | 62 |
| 5 | 180^{a} | H7-H8 | 37 | 59 |
| 6 | 180 | H7-H8 | 34 | 59 |
| 7 | 180 | Coir | 35 | 62 |
| 8 | 180^{b} | H3-H4 | 35 | 56 |
| 9 | 180^{c} | H3-H4 | 35 | 57 |
| 10 | 200^{a} | H3-H4 | 48 | 53 |

^{a}Dried to 14% w/w H₂O
^{b}NiO used as the catalyst
^{c}KOH used as a co-catalyst

TABLE 2
Weight yields of product oil after distillation of 11.6048 g of oil

| | | Weight of fraction | | Weight | |
|---|---|---|---|---|---|
| Entry | T (° C.) | Fraction 1 | Fraction 2 | (g) | (%) |
| 1 | 100 | 0.4597 | 0.7864 | 1.2461 | 10.7 |
| 2 | 120 | 0.2808 | 0.4888 | 0.7696 | 6.6 |
| 3 | 140 | 0.1104 | 0.5363 | 0.6467 | 5.6 |
| 4 | 160 | 0.1692 | 0.4063 | 0.5755 | 5.0 |
| 5 | 180 | 0.0653 | 0.6563 | 0.7216 | 6.2 |
| 6 | 200 | 0.0616 | 0.5453 | 0.6069 | 5.2 |
| 7 | 250 | 0.0784 | 0.9297 | 1.0081 | 8.7 |
| 8 | Residual | | | 5.6371 | 48.6 |
| 9 | Extractable | | | 0.9361 | 8.1 |
| | Residual^{a} | | | | |

^{a}extraction from the residual with toluene

TABLE 3
Elemental analysis of product oil

| | | Humification | Elemental composition (%) | | | | | |
|---|---|---|---|---|---|---|---|---|
| Entry | T (° C.) | level | N | C | H | S | O | Ash |
| 1 | 180^{a,d} | H3-H4 | 1.19 ± 0.01 | 58.09 ± 0.11 | 6.64 ± 0.01 | 0 | 33.77 ± 1.08 | 0.31 ± 0.26 |
| 2 | 180^{a,d} | H7-H8 | 1.71 ± 0.03 | 58.43 ± 0.48 | 6.89 ± 0.04 | 0.16 ± 0.03 | 32.94 ± 0.73 | 0.03 ± 0.14 |
| 3 | 180^{d} | COIR | 0.57 ± 0.03 | 48.26 ± 0.70 | 5.06 ± 0.06 | 0.12 ± 0.04 | 35.69 ± 1.49 | 10.29 ± 0.66 |
| 4 | 180^{a} | H3-H4 | 0.97 ± 0.01 | 50.95 ± 1.55 | 8.19 ± 0.23 | 0 | 38.86 ± 1.91 | 1.02 ± 0.12 |
| 5 | 180^{a} | H5-H6 | 1.26 ± 0.01 | 54.33 ± 0.37 | 8.56 ± 0.05 | 0 | 35.72 ± 0.61 | 0.13 ± 0.19 |
| 6 | 180^{a} | H6-H7 | 0.80 ± 0.01 | 55.78 ± 0.14 | 8.53 ± 0.01 | 0 | 34.56 ± 0.24 | 0.33 ± 0.08 |
| 7 | 180 | H6-H7 | 0.83 ± 0.01 | 55.33 ± 0.40 | 8.63 ± 0.05 | 0 | 34.66 ± 0.48 | 0.56 ± 0.02 |
| 8 | 180^{a} | H7-H8 | 1.15 ± 0.03 | 55.02 ± 1.42 | 9.03 ± 0.21 | 0 | 34.48 ± 1.73 | 0.33 ± 0.08 |
| 9 | 180 | H7-H8 | 1.45 ± 0.01 | 59.52 ± 1.55 | 8.65 ± 0.23 | 0 | 30.11 ± 1.91 | 0.28 ± 0.12 |
| 10 | 180 | Coir | 1.07 ± 0.01 | 53.97 ± 0.55 | 8.79 ± 0.13 | 0 | 35.24 ± 0.76 | 0.94 ± 0.08 |
| 11 | 180^{b} | H3-H4 | 0.46 ± 0.02 | 47.62 ± 0.37 | 7.48 ± 0.03 | 0 | 39.94 ± 0.49 | 4.50 ± 0.07 |
| 12 | 180^{c} | H3-H4 | 0.91 ± 0.01 | 50.2 ± 1.13 | 8.36 ± 0.12 | 0 | 32.96 ± 1.90 | 7.59 ± 0.64 |
| 13 | 200^{a} | H3-H4 | 0.90 ± 0.02 | 56.91 ± 0.47 | 9.09 ± 0.03 | 0 | 32.68 ± 0.56 | 0.42 ± 0.04 |
| 14 | N/A | Wood | 0-0.2 | 55-58 | 5.5-7 | 0 | 35-40 | N/D |
| | | Pyrolysis^{e} | | | | | | |

^{a}Dried to 14% w/w H₂O
^{b}NiO used as the catalyst
^{c}KOH used as a co-catalyst
^{d}Non-catalytic process
^{e}M. I. Jahirul, M. G. Rasul, A. A. Chowdhury, N. Ashwath, Energies 2012, 5, 4952-5001

TABLE 4
Elemental analysis of product oil after distillation of 11.6048 g of oil

| | | | Elemental composition (%) | | | | |
|---|---|---|---|---|---|---|---|
| Entry | T (° C.) | Fraction | N | C | H | S | O |
| 1 | 100 | 1 | 0.35 ± 0.06 | 43.15 ± 4.46 | 9.17 ± 0.92 | 0 | 47.32 ± 5.43 |
| 2 | 100 | 2 | 0.72 ± 0.03 | 53.80 ± 1.24 | 10.18 ± 0.12 | 0 | 35.35 ± 1.39 |
| 3 | 120 | 1 | 0.58 ± 0.02 | 39.33 ± 1.48 | 7.34 ± 0.25 | 0 | 52.84 ± 1.75 |
| 4 | 120 | 2 | 0.89 ± 0.02 | 51.43 ± 0.47 | 9.29 ± 0.03 | 0 | 38.40 ± 0.52 |
| 5 | 140 | 1 | 1.07 ± 0.03 | 53.48 ± 1.04 | 9.19 ± 0.01 | 0 | 36.25 ± 1.08 |
| 6 | 140 | 2 | 0.86 ± 0.02 | 48.70 ± 0.51 | 8.90 ± 0.09 | 0 | 41.50 ± 0.62 |
| 7 | 160 | 1 | 1.55 ± 0.09 | 53.37 ± 3.03 | 9.37 ± 0.37 | 0 | 35.73 ± 3.48 |
| 8 | 160 | 2 | 0.75 ± 0.01 | 53.08 ± 1.63 | 9.33 ± 0.26 | 0 | 36.84 ± 1.90 |
| 9 | 180 | 1 | 1.28 ± 0.07 | 52.70 ± 0.58 | 8.78 ± 0.13 | 0 | 37.24 ± 0.78 |
| 10 | 180 | 2 | 0.90 ± 0.08 | 50.60 ± 4.41 | 8.81 ± 0.63 | 0 | 39.69 ± 5.11 |
| 11 | 200 | 1 | 1.14 ± 0.04 | 51.57 ± 0.99 | 8.52 ± 0.09 | 0 | 38.73 ± 1.11 |
| 12 | 200 | 2 | 0.91 ± 0.05 | 59.60 ± 1.99 | 9.75 ± 0.23 | 0 | 29.74 ± 2.26 |
| 13 | 250 | 2 | 0.81 ± 0.03 | 54.02 ± 2.20 | 8.82 ± 0.36 | 0 | 36.33 ± 2.58 |

TABLE 5
compounds detected in the product oil after GC × GC analysis of
product oil

| Entry | Molecule |
|---|---|
| 1 | 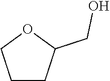 |
| 2 | 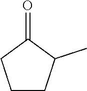 |
| 3 | 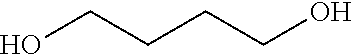 |
| 4 | 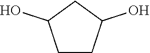 |
| 5 | 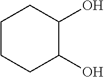 |
| 6 | 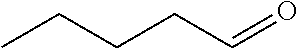 |
| 7 | 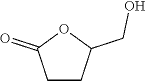 |
| 8 | 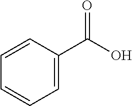 |
| 9 | 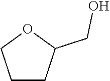 |
| 10 | 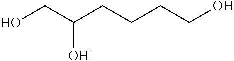 |
| 11 | 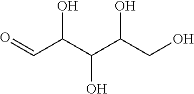 |
| 12 | 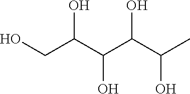 |
| 13 | 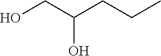 |
| 14 | 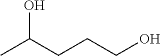 |
| 15 | 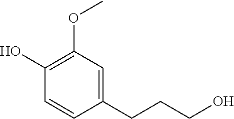 |
| 16 | 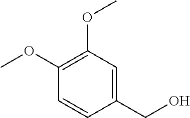 |
| 17 | 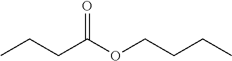 |
| 18 | 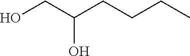 |
| 19 | 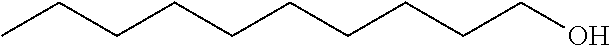 |
| 20 | 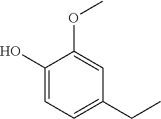 |
| 21 | 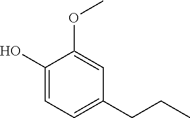 |
| 22 | C₁₂OH |
| 23 | C₈H₃₆ |
| 24 | C₂₀H₄₀ |
| 25 | C₁₈H₃₄O₂ |
| 26 | C₁₈H₃₈O |
| 27 | C₂₂H₄₆O |
| 28 | C₁₈H₃₈O |
| 29 | C₁₈H₃₅NO |
| 30 | C₂₂H₄₃NO |
| 31 | 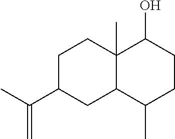 [SMILES: C=C(C)C1CCC2(C)C(O)CCC(C)C2C1] |
| 32 | 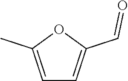 |
| 33 | 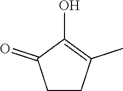 |
| 34 | 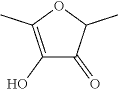 |
| 35 | 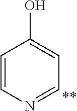 |
| 36 | 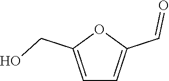 |
| 37 | 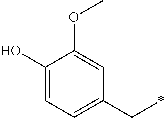 [SMILES: *Cc1ccc(O)c(OC)c1] |
| 38 | 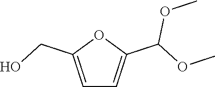 |
| 39 | 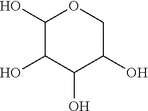 |
| 40 | 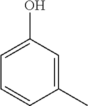 |
| 41 | 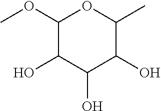 |
| 42 | 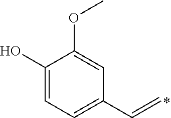 |
| 43 | 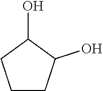 |
| 44 | 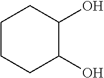 |
| 45 | 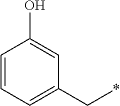 [SMILES: *Cc1cccc(O)c1] |
| 46 | 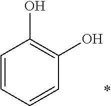 |
| 47 | 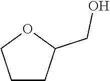 |
| 48 | 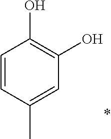 |
| 49 | 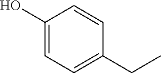 |
| 50 | 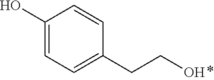 |
| 51 | 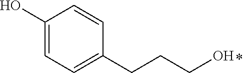 [SMILES: OCCCc1ccc(O)cc1] |
| 52 | 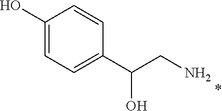 [SMILES: NCC(O)c1ccc(O)cc1] |
| 53 | 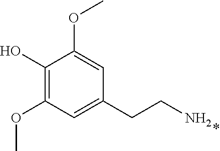 |
| 54 | 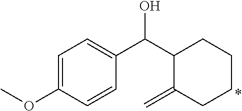 [SMILES: C=C1CCCCC1C(O)c1ccc(OC)cc1] |
| 55 | 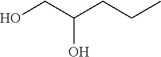 |
| 56 | 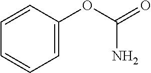 |
| 57 | 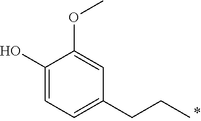 |
| 58 | 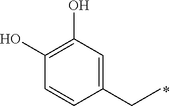 |
| 59 | 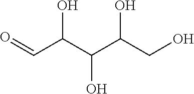 |
| 60 | 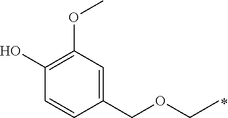 |
| 61 | 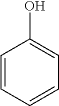 |
| 62 | 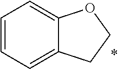 |

* Only detected in samples of coir
**Only detected in organosolv peat

### EXAMPLES

The following examples are intended to illustrate the present invention without limiting the invention in any way.

### Example 1

### Reference Process (Ordanosolv Process)

Peat (10 g, 14% H₂O, H3-H4, Terracult) was suspended in a 150 mL solution of 2-PrOH:water (7:3, v/v) in a 250 mL autoclave equipped with a mechanical stirrer. The suspension was heated from 25 to 180° C. within 1 h under mechanical stirring. The autogenous pressure at 180° C. is 25 bar. The suspension was processed at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown solid was obtained (FIG. 1A). In turn, the solid fraction was washed with acetone, and then dried under vacuum evaporation. From 8.6 g of peat, 3.15 g of solid product leached from peat and 5.18 g solid fraction were obtained.

### Example 2

### Reference Process (Ordanosolv Process)

Peat (10 g, 14% H₂O, H7-H8, Terracult) was suspended in a 150 mL solution of 2-PrOH:water (7:3, v/v) in a 250 mL autoclave equipped with a mechanical stirrer. The suspension was heated from 25 to 180° C. within 1 h under mechanical stirring. The autogenous pressure at 180° C. is 25 bar. The suspension was processed at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown solid was obtained (FIG. 1A). In turn, the solid fraction was washed with acetone, and then dried under vacuum evaporation. From 8.6 g of peat, 2.52 g of solid product leached from peat and 5.65 g solid fraction were obtained.

### Example 3

### Reference Process (Ordanosolv Process)

Coir (15 g, 57% H₂O, Terracult) was suspended in a 150 mL solution of 2-PrOH:water (7:3, v/v) (inclusive of the original H₂O content in the peat) in a 250 mL autoclave equipped with a mechanical stirrer. The suspension was heated from 25 to 180° C. within 1 h under mechanical stirring. The autogenous pressure at 180° C. is 25 bar. The suspension was processed at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown solid was obtained (FIG. 1A). In turn, the solid fraction was washed with acetone, and then dried under vacuum evaporation. From 6.4 g of peat, 2.52 g of solid product leached from peat and 4.76 g solid fraction were obtained.

### Example 4

### Inventive Process (Catalytic Fractionation of Peat)

Peat (15 g, 14% H₂O, H3-H4, Terracult) and skeletal Ni catalyst (10 g, Raney Ni prepared from Ni—Al alloy 50/50 w/w %, Sigma-Aldrich) was suspended in a 150 mL solution of 2-PrOH:water (7:3, v/v) in a 250 mL autoclave equipped with a mechanical stirrer. The suspension was heated from 25 to 180° C. within 1 h under mechanical stirring. The suspension was processed under autogeneous pressure at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown oil (product oil) was obtained. In turn, the solid fraction was washed with acetone, and then dried under vacuum evaporation. From 12.9 g of Peat, 5.15 g of product oilproduct oil and 6.98 g solid fraction were obtained (Table 1, entry 1).

### Example 5

### Inventive Process (Catalytic Fractionation of Peat)

Peat (10 g, 14% H₂O, H3-H4, Terracult) and skeletal Ni catalyst (8 g, Raney Ni prepared from Ni—Al alloy 50/50 w/w %, Sigma-Aldrich) was suspended in a 150 mL solution of 2-PrOH:water (7:3, v/v) in a 250 mL autoclave equipped with a mechanical stirrer. The suspension was heated from 25 to 200° C. within 1 h under mechanical stirring. The suspension was processed under autogeneous pressure at 200° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown oil (product oil) was obtained. In turn, the solid fraction was washed with acetone, and then dried under vacuum evaporation. From 8.6 g of Peat, 4.15 g of product oilproduct oil and 4.16 g solid fraction were obtained (Table 1, entry 1).

### Example 6

### Inventive Process (Catalytic Fractionation of Peat)

Peat (15 g, 14% H₂O, H5-H6, Terracult) and skeletal Ni catalyst (10 g, Raney Ni prepared from Ni—Al alloy 50/50 w/w %, Sigma-Aldrich) was suspended in a 150 mL solution of 2-PrOH:water (7:3, v/v) in a 250 mL autoclave equipped with a mechanical stirrer. The suspension was heated from 25 to 180° C. within 1 h under mechanical stirring. The suspension was processed under autogeneous pressure at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown oil (product oil) was obtained. In turn, the solid fraction was washed with acetone, and then dried under vacuum evaporation. From 12.9 g of Peat, 3.69 g of product oil and 7.84 g solid fraction were obtained (Table 1, entry 1).

### Example 7

### Inventive Process (Catalytic Fractionation of Peat)

Peat (15 g, 14% H₂O, H6-H7, Terracult) and skeletal Ni catalyst (10 g, Raney Ni prepared from Ni—Al alloy 50/50 w/w %, Sigma-Aldrich) was suspended in a 150 mL solution of 2-PrOH:water (7:3, v/v) in a 250 mL autoclave equipped with a mechanical stirrer. The suspension was heated from 25 to 180° C. within 1 h under mechanical stirring. The suspension was processed under autogeneous pressure at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown oil (product oil) was obtained. In turn, the solid fraction was washed with acetone, and then dried under vacuum evaporation. From 12.9 g of Peat, 4.36 g of product oil and 7.5 g solid fraction were obtained (Table 1, entry 1).

### Example 8

### Inventive Process (Catalytic Fractionation of Peat)

Peat (37.5 g, 61.2% H₂O, H6-H7, Terracult) and skeletal Ni catalyst (10 g, Raney Ni prepared from Ni—Al alloy 50/50 w/w %, Sigma-Aldrich) was suspended in a 150 mL solution of 2-PrOH:water (7:3, v/v) (inclusive of the original H₂O content in the peat) in a 250 mL autoclave equipped with a mechanical stirrer. The suspension was heated from 25 to 180° C. within 1 h under mechanical stirring. The suspension was processed under autogeneous pressure at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown oil (product oil) was obtained. In turn, the solid fraction was washed with acetone, and then dried under vacuum evaporation. From 15.3 g of Peat, 4.27 g of product oil and 8.96 g solid fraction were obtained (Table 1, entry 1).

### Example 9

### Inventive Process (Catalytic Fractionation of Peat)

Peat (15 g, 14% H₂O, H7-H8, Terracult) and skeletal Ni catalyst (10 g, Raney Ni prepared from Ni—Al alloy 50/50 w/w %, Sigma-Aldrich) was suspended in a 150 mL solution of 2-PrOH:water (7:3, v/v) (inclusive of the original H₂O content in the peat) in a 250 mL autoclave equipped with a mechanical stirrer. The suspension was heated from 25 to 180° C. within 1 h under mechanical stirring. The suspension was processed under autogeneous pressure at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown oil (product oil) was obtained. In turn, the solid fraction was washed with acetone, and then dried under vacuum evaporation. From 12.9 g of Peat, 4.79 g of product oil and 7.6 g solid fraction were obtained (Table 1, entry 1).

### Example 10

### Inventive Process (Catalytic Fractionation of Peat)

Peat (48.6 g, 69.6% H₂O, H7-H8, Terracult) and skeletal Ni catalyst (10 g, Raney Ni prepared from Ni—Al alloy 50/50 w/w %, Sigma-Aldrich) was suspended in a 150 mL solution of 2-PrOH:water (7:3, v/v) (inclusive of the original H₂O content in the peat) in a 250 mL autoclave equipped with a mechanical stirrer. The suspension was heated from 25 to 180° C. within 1 h under mechanical stirring. The suspension was processed under autogeneous pressure at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown oil (product oil) was obtained. In turn, the solid fraction was washed with acetone, and then dried under vacuum evaporation. From 14.8 g of Peat, 4.99 g of product oil and 8.73 g solid fraction were obtained (Table 1, entry 1).

### Example 11

### Inventive Process (Catalytic Fractionation of Peat)

Peat (18.25 g, 54.8% H₂O, H3-H4, Terracult) and skeletal Ni catalyst (8 g, skeletal NiO prepared from Ni—Al alloy 50/50 w/w %, Sigma-Aldrich and left in air for oxidation) was suspended in a 150 mL solution of 2-PrOH:water (7:3, v/v) (inclusive of the original H₂O content in the peat) in a 250 mL autoclave equipped with a mechanical stirrer. The suspension was heated from 25 to 180° C. within 1 h under mechanical stirring. The suspension was processed under autogeneous pressure at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown oil (product oil) was obtained. In turn, the solid fraction was washed with acetone, and then dried under vacuum evaporation. From 8.25 g of Peat, 2.89 g of product oil and 4.64 g solid fraction were obtained (Table 1, entry 1).

### Example 12

### Inventive Process (Catalytic Fractionation of Peat)

Peat (18.25 g, 54.8% H₂O, H3-H4, Terracult) and skeletal Ni catalyst (8 g, Raney Ni prepared from Ni—Al alloy 50/50 w/w %, Sigma-Aldrich) with 0.6186 g KOH as a co-catalyst, was suspended in a 150 mL solution of 2-PrOH:water (7:3, v/v) (inclusive of the original H₂O content in the peat) in a 250 mL autoclave equipped with a mechanical stirrer. The suspension was heated from 25 to 180° C. within 1 h under mechanical stirring. The suspension was processed under autogeneous pressure at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown oil (product oil) was obtained. In turn, the solid fraction was washed with acetone, and then dried under vacuum evaporation. From 8.25 g of Peat, 2.92 g of product oil and 4.74 g solid fraction were obtained (Table 1, entry 1).

### Example 13

### Inventive Process (Catalytic Fractionation of Peat)

Coir (15 g, 57% H₂O, Terracult) and skeletal Ni catalyst (10 g, Raney Ni prepared from Ni—Al alloy 50/50 w/w %, Sigma-Aldrich) was suspended in a 150 mL solution of 2-PrOH:water (7:3, v/v) in a 250 mL autoclave equipped with a mechanical stirrer. The suspension was heated from 25 to 180° C. within 1 h under mechanical stirring. The suspension was processed under autogeneous pressure at 180° C. for 3 h. In sequence, the mixture was left to cool down to room temperature. A brown solution was obtained after filtering off the peat fibers (solid fraction). The solvent was removed at 60° C. using a rotoevaporator. After solvent removal, a brown oil (product oil) was obtained. In turn, the solid fraction was washed with acetone, and then dried under vacuum evaporation. From 6.4 g of Peat, 2.24 g of product oil and 3.96 g solid fraction were obtained (Table 1, entry 1).

### Example 14

### Distillation of the Oil

Vacuum distillation of an 11.6048 g product oil was carried out in a Buchi Glass Oven B-585 with two fractions collected at 100° C. 120° C., 140° C., 160° C., 180° C., 200° C. and 250° C. From the starting oil mixture 5.6371 g was not distilled below 250° C., 4.116 g and 0.5700 g of oil was distilled in fraction 1 and 2 at 100° C. respectively, 0.2808 g and 0.4888 g of oil was distilled in fraction 1 and 2 at 120° C. respectively, 0.1104 g and 0.5363 g of oil was distilled in fraction 1 and 2 at 140° C. respectively, 0.1692 g and 0.4063 g of oil was distilled in fraction 1 and 2 at 160° C. respectively, 0.0653 g and 0.6563 g of oil was distilled in fraction 1 and 2 at 180° C. respectively, 0.0616 g and 0.5453 g of oil was distilled in fraction 1 and 2 at 250° C. respectively, 0.0784 g and 0.9297 g of oil was distilled in fraction 1 and 2 at 250° C. respectively. The char fraction with a distillation value above 250° C. was 5.6371 g. From the char fraction an extraction with toluene yielded a 0.9361 g toluene soluble fraction. The results are summarized in table 2.

Analysis of the Products

The determination of humidity of the solid fraction and starting material was determined on a thermobalance (Ohaus MB25). Typically, the samples (2 to 3 g) were heated up to 105° C. for 20 min. The humidity was determined as the weight loss after 20 min.

The reaction mixtures were analyzed using 2D GC×GC-MS (1st column: Rxi-1 ms 30 m, 0.25 mm ID, df 0.25 μm; 2nd column: BPX50, 1 m, 0.15 mm ID, df 0.15 μm) in a GC-MS-FID 2010 Plus (Shimadzu) equipped with a ZX1 thermal modulation system (Zoex). The temperature program started with an isothermal step at 40° C. for 5 min. Next, the temperature was increased from 40 to 300° C. by 5.2° C. min⁻¹. The program finished with an isothermal step at 300° C. for 5 min. The modulation applied for the comprehensive GC×GC analysis was a hot jet pulse (400 ms) every 9000 ms. The 2D chromatograms were processed with GC Image software (Zoex). The products were identified by a search of the MS spectrum with the MS library NIST 08, NIST 08s, and Wiley 9. Summary of the compounds identified by MS spectrum comparison are in table 5.

1. Process for catalytic fractionation of peat or peat-like substrates for the production of product oil in addition to a solid capable of high water retention with a high volume, the process comprising the steps of:
a. subjecting optionally particulate peat material to a treatment at the temperature range from 130° C. to 300° C., in a solvent system comprising an organic solvent or mixture of solvents in the presence of a transition metal in absence of externally supplied molecular hydrogen, under autogeneous pressure in a reaction vessel for a reaction time of 0.01 to 8 hours,
b. removing the catalyst from the reaction mixture,
c. filtering the reaction mixture to separate the raw product oil from the solid fraction, and optionally
d. removing the solvent system from the filtrate to concentrate the product oil.

2. Process according to claim 1, wherein the material is a peat.

3. Process according to claim 1, wherein the solvent system comprises an organic solvent that is miscible with water.

4. Process according to claim 1, wherein the solvent system can be a solvent mixture of a lower aliphatic alcohol having 1 to 6 carbon atoms and water.

5. Process according to claim 1, wherein the solvent system is a solvent mixture of secondary alcohols and water in a v/v-ratio of alcohol/water of 80/20 to 20/80.

6. Process according to claim 1, wherein the solvent system additionally comprises at least one further solvent selected from the group consisting of: aliphatic or aromatic ketones having 1 to 10 carbon atoms, ethers having 2 to 10 carbon atoms, cyclohexanols, cyclic ethers, and esters.

7. Process according to claim 6, wherein the volume fraction of a modifier in the solvent mixture, also containing secondary alcohol or mixture thereof and eventually water, ranges from 0.1 to 99.9%.

8. The process as claimed in claim 1, wherein the metal catalyst can be a skeletal transition metal catalyst or supported transition metal catalyst or mixture thereof.

9. The process as claimed in claim 8, wherein the metal is selected from the group consisting of: nickel, iron, cobalt, copper, ruthenium, palladium, rhodium, osmium iridium, rhenium and mixtures thereof.

10. The process as claimed in claim 1, wherein the catalyst is a bifunctional solid comprising metal functionality and acid sites, said acid sites being optionally functional sites having acidic Brønsted or Lewis functionality or both.

11. The process as claimed in claim 1, wherein the catalyst is a transition metal oxide as in any oxide form of nickel, iron, cobalt, copper, ruthenium, palladium, rhodium, osmium iridium, rhenium or mixtures thereof.

12. The process as claimed in claim 1, wherein the catalyst is co-catalyzed by a base comprising of alkali metals, alkali earth metals, or any organic base which includes nitrogen in the organic structure.

13. Process according to claim 1, wherein the catalyst is used at weight ratio of catalyst-to-substrate from 0.001 to 10.
